(19) United States
(12) Patent Application Publication
(10) Pub. No.: US 2003/0201132 A1
(43) Pub. Date: Oct. 30, 2003

(54) Steerable drive unit

(76) Inventor: Daniel L. Mikrut, Chillicothe, IL (US)

Correspondence Address: CATERPILLAR INC., 100 N.E. ADAMS STREET, PATENT DEPT., PEORIA, IL, 616296490

(21) Appl. No.: 10/135,751

(22) Filed: Apr. 30, 2002

(51) Int. Cl. B60K 17/30

(52) U.S. Cl. 180/253

(57) ABSTRACT

An apparatus for providing a steerable drive unit. The apparatus includes a ground engaging member, a final drive connected to the ground engaging member, a motor drivably engaged with the final drive, and a carrier connected to the motor and the final drive, the carrier including means for connecting to a steering linkage assembly.

### TECHNICAL FIELD

This invention relates generally to an apparatus for providing a steerable drive unit and, more particularly, to an apparatus having a carrier attached to a motor and a final drive and attached to a ground engaging member to provide a steerable drive unit.

### BACKGROUND

It is becoming increasingly common to use individual motors to drive ground engaging members of mobile machines. For example, electric or hydraulic motors may be used to provide drive power to wheels and tires of mobile machines, with one motor dedicated per wheel.

In typical configurations, the motors are mounted so that they receive electric, hydraulic or some such power, and in turn deliver mechanical power directly to the wheels. More specifically, each motor is mounted directly to each respective wheel.

If the wheels also happen to be steerable, then the mounted motors, and any other relevant components, must be configured to allow proper steering and not impede the steering functions. For example, in U.S. Pat. No. 4,557,346, Guignard et al. disclose a steering and drive system which includes hydraulic motors mounted directly to the wheels. The wheels are steerable, and thus the motors must be allowed to rotate with the wheels as steering takes place. The steering system, therefore, is configured to provide the needed clearance for the motors to allow freedom of movement.

The '346 patent, however, is directed to a relatively small machine which is powered directly by the motors, i.e., no drive systems needed. In particular, the types of uses described in the '346 patent include warehouse vehicles which are used to change light bulbs and perform similar maintenance. The configuration disclosed in the '346 patent would not be suitable for larger mobile machines, such as earthworking machines, which are used in adverse environments, operate at higher speeds, and generate substantial amounts of torque in the drive systems. Furthermore, larger mobile machines require additional drive components, such as final drives, which add to the complexity and requirements of the steerable drive systems.

The present invention is directed to overcoming one or more of the problems as set forth above.

### SUMMARY OF THE INVENTION

In one aspect of the present invention an apparatus for providing a steerable drive unit is disclosed. The apparatus includes a ground engaging member, a final drive connected to the ground engaging member, a motor drivably engaged with the final drive, and a carrier connected to the motor and the final drive, the carrier including means for connecting to a steering linkage assembly.

In another aspect of the present invention an apparatus for providing a steerable drive unit is disclosed. The apparatus includes a first and a second ground engaging member, a first final drive connected to the first ground engaging member and a second final drive connected to the second ground engaging member, a first motor drivably engaged with the first final drive and a second motor drivably engaged with the second final drive, and a first carrier connected to the first motor and the first final drive and a second carrier connected to the second motor and the second final drive, the first and second carriers including respective first and second connection brackets for connecting to a steering linkage assembly.

In yet another aspect of the present invention an apparatus for providing a steerable drive unit is disclosed. The apparatus includes a ground engaging member including a wheel and a tire mounted thereon, a final drive located within an inner portion of the ground engaging member and having a rotating portion fixedly attached to the ground engaging member, a carrier located within the inner portion of the ground engaging member and attached to a non-rotating portion of the final drive, the carrier being essentially cylindrical with a hollow inner portion, and a motor positioned within the hollow inner portion of the carrier, attached to the carrier, and drivably engaged with the final drive.

In yet another aspect of the present invention an axle for supporting a steerable drive unit is disclosed. The axle includes an essentially tubular main portion, a first end having a top portion, a bottom portion, and an open area between the top and bottom portions, a second end having a top portion, a bottom portion, and an open area between the top and bottom portions, a pivot hinge located at each of the top and bottom portions of the first and second ends, and an oscillation pivot located essentially toward the center of the main portion, wherein each set of pivot hinges at each of the first and second ends are pivotally connected to a steerable drive unit.

In yet another aspect of the present invention a carrier for a steerable drive unit is disclosed. The carrier includes an essentially cylindrical hollow inner portion for locating a motor therein, a first end fixedly attached to a non-rotating portion of a final drive, the final drive including a rotating portion fixedly attached to a ground engaging member, the motor being drivably engaged with the final drive, and a second end having means for connecting to a set of pivot hinges located on an axle, the second end further including a connection bracket for connecting to a steering linkage assembly.

### BRIEF DESCRIPTION OF THE DRAWINGS

FIG. 1 is a diagrammatic illustration of a mobile machine suited for use with the present invention;

FIG. 2 is a diagrammatic illustration of a preferred embodiment of the present invention;

FIG. 3 is an exploded view of the preferred embodiment of FIG. 2;

FIG. 4 is a diagrammatic illustration of a preferred embodiment of an axle suitable for use with the present invention;

FIG. 5 is a diagrammatic illustration of a top view of the preferred embodiment of the present invention;

FIG. 6 is a sectional side view of the preferred embodiment of FIG. 5; and

FIG. 7 is the top view of FIG. 5 including a representation of a steering linkage assembly.

### DETAILED DESCRIPTION

Referring to the drawings and the appended claims, an apparatus 100 for providing a steerable drive unit 202 is disclosed.

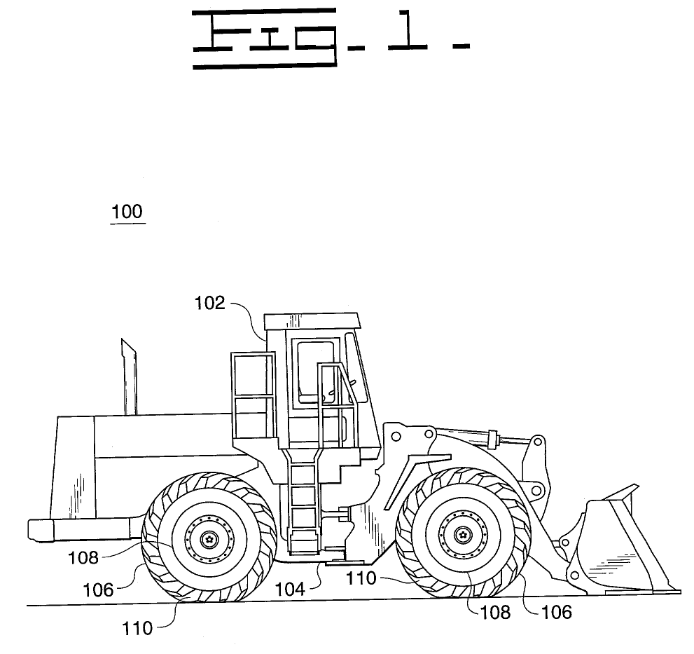

Referring in particular to FIG. 1, a diagrammatic illustration of a mobile machine 102 having a frame 104 is shown. The mobile machine 102 is depicted as a wheel loader, suited for earthworking tasks such as mining, construction, and the like. However, for purposes of the present invention, any type of mobile machine 102 may benefit from use of the present invention.

In the embodiment shown, the mobile machine 102 includes at least one ground engaging member 106, such as a plurality of wheels 108 having tires 110 mounted thereon. For example, the mobile machine 102 in FIG. 1 displays two ground engaging members 106 in the profile shown. It is well known that a mobile machine 102 of the type shown in FIG. 1 will have two additional ground engaging members 106 on the opposite side, for a total of four ground engaging members 106. However, any number of ground engaging members 106 may be used, for example 6, 8, 10 or some other such number. Furthermore, the ground engaging members need not necessarily be wheels and tires. For example, the ground engaging members 106 may be tracks of a track-type machine.

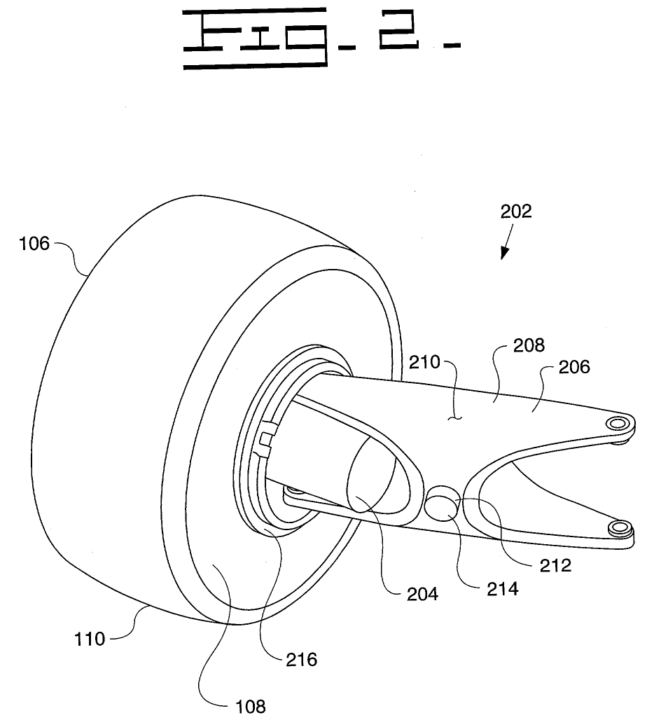

Referring to FIG. 2, a diagrammatic illustration of a preferred embodiment of the present invention is shown. For purposes of explanation, only one ground engaging member 106 is displayed. However, a like configuration may exist for additional ground engaging members 106 on the mobile machine 102 as well, as shown below.

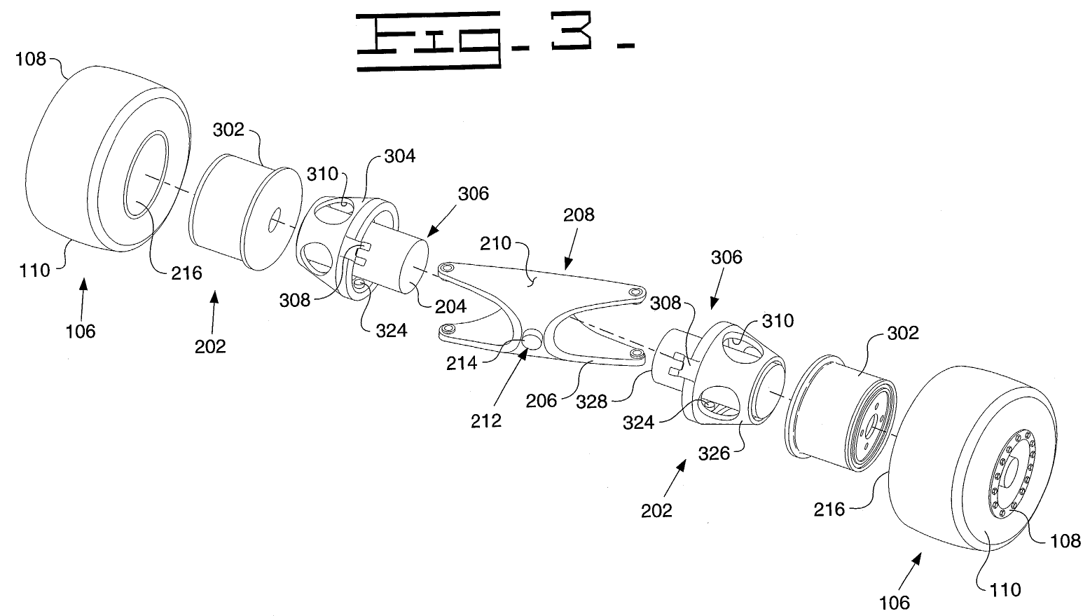

The preferred embodiment of FIG. 2 illustrates a steerable drive unit 202. In the embodiment shown, the steerable drive unit 202 includes the ground engaging member 106, a final drive 302 connected to the ground engaging member 106, a motor 204 drivably engaged with the final drive 302, and a carrier 304 connected to the motor 204 and the final drive 302. The components, in particular the final drive 302 and the carrier 304, are shown more clearly in the exploded view of FIG. 3. Preferably, the carrier 304 includes means 306 for connecting to a steering linkage assembly 702. For example, the carrier 304 may include a connection bracket 308.

In the preferred embodiment, the final drive 302 is located within an inner portion 216 of the ground engaging member 106. For example, if the ground engaging member 106 includes a wheel 108, the final drive 302 is preferably located within the wheel 108 essentially at the center of the wheel 108. In addition, the carrier 304 is preferably located within the inner portion 216 of the ground engaging member 106.

The motor 204 may be electric, hydraulic or some other type. Typical motors used to provide power to ground engaging members are well known in the art and are therefore not further described.

The carrier 304 preferably includes a cylindrical inner portion 310 to allow positioning of the motor 204 within the carrier 304, thus placing the motor 204 adjacent the final drive 302 for drivably engaging the final drive 302. The carrier 304, as shown in FIG. 3, includes a series of open holes to allow air circulation and to provide a lighter weight without sacrificing strength. However, the carrier 304 could just as well be constructed without any holes or with some other type of air vent arrangement, such as meshed portions or a series of narrow slits for example.

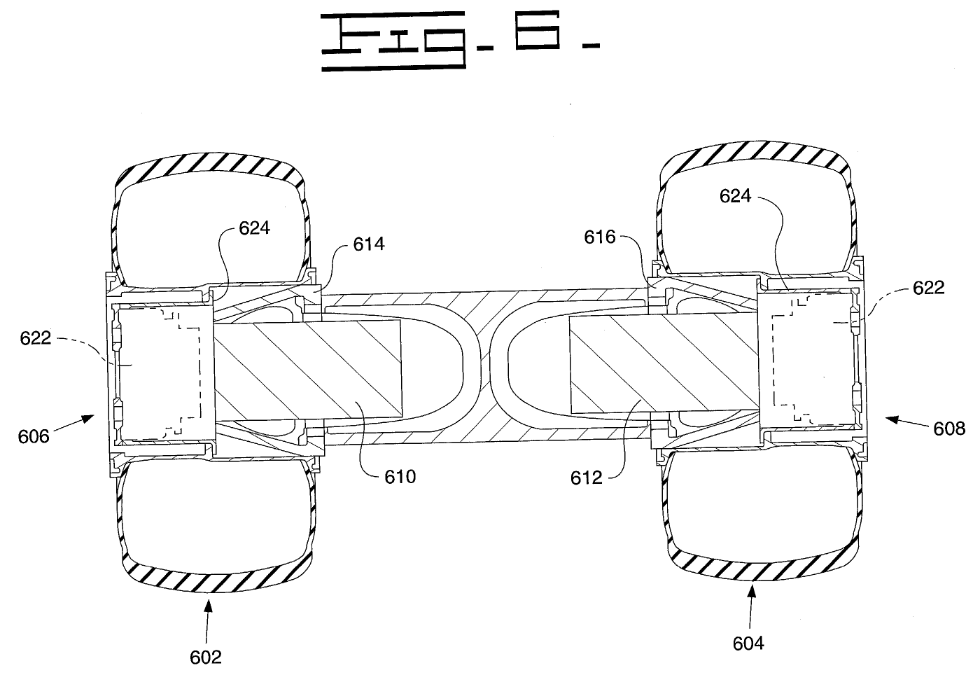

The final drive 302 is typically of a type well known in the art, such as a set of planetary gears which might include sun gears, ring gears, and the like. The final drive 302 is preferably configured to provide different output torque and speed ratios dependent upon the required driving conditions and speed. Preferably, as embodied in FIG. 6, the final drive 302 includes a rotating portion 622 which is connected to the ground engaging member 106, for example by bolts. The final drive 302 also includes a non-rotating portion 624, to which the carrier 304 is connected, for example by bolts. Thus, the carrier 304 and the non-rotating portion 624 of the final drive 302 remain essentially stationary while the rotating portion 622 of the final drive 302, being drivably engaged by the motor 204, in turn drivably engages the ground engaging member 106.

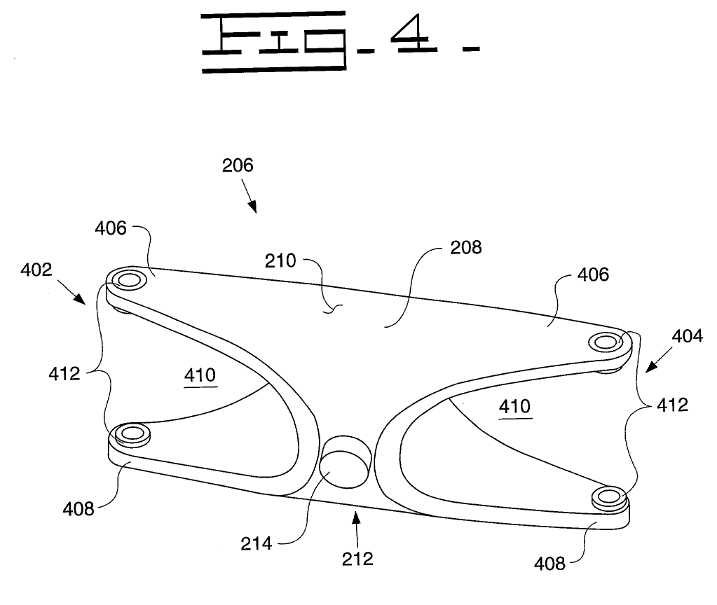

Referring again to FIG. 2 and also referring to FIGS. 3 and 4, an axle 206 is pivotally connected to the carrier 304, as is described in more detail below. Preferably, the axle 206 includes a main portion 208 which is essentially tubular in shape to increase the strength of the axle 206 without requiring undue weight. The axle 206 has a first end 402 pivotally connected to the carrier 304 and a second end 404 pivotally connected to an other carrier 326. The first end 402 of the axle 206 has a top portion 406 and a bottom portion 408 and an open area 410 between the top an bottom portions 406,408. The open area 410 provides a space for the motor 204 so that the motor 204 can pivot as the ground engaging member 106 is steered. In like manner, the second end 404 has a top portion 406, a bottom portion 408 and an open area 410 between the top and bottom portions 406,408 to provide a space for an other motor 328.

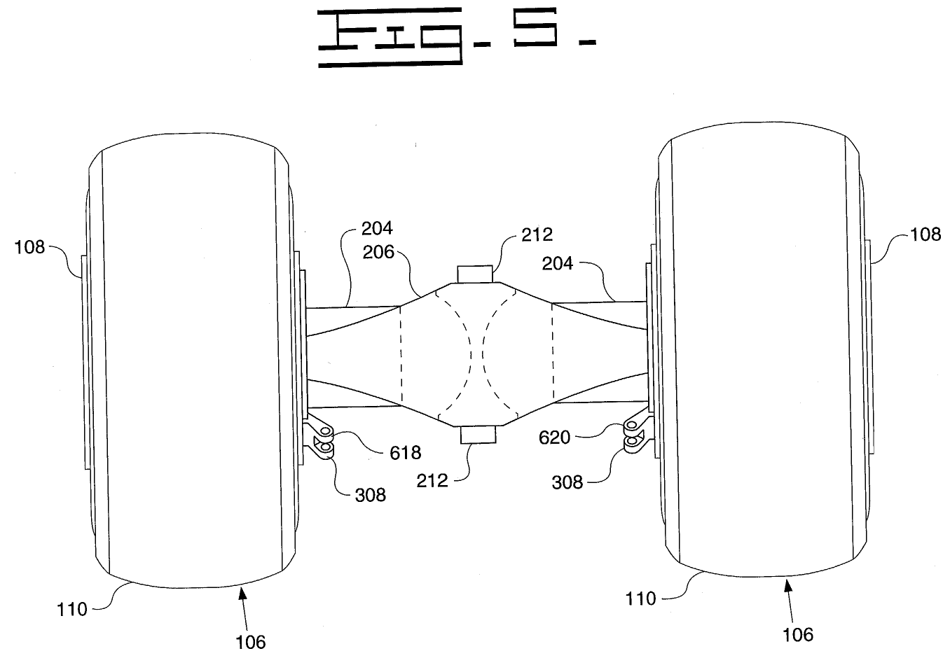

A center portion 210 of the axle 206 preferably includes at least one oscillation pivot 212. In the preferred embodiment, the oscillation pivot 212 includes a pin and bushing joint 214. The oscillation pivot 212 provides a connection point to the frame 104 so that the axle 206 is allowed to pivot somewhat as the ground engaging members 106 rise and fall during movement of the mobile machine 102, thus reducing torsional stresses on the frame 104. As FIG. 4 illustrates, an oscillation pivot 212 is shown on the facing side of the axle 206. An oscillation pivot 212 also exists on the opposite side of the axle 206, as evident from the top view of FIG. 5. The oscillation pivot 212 may be one component which extends through the center portion 210 of the axle 206, or may be two separate components, one on each side of the axle 206.

The first and second ends 402,404 of the axle 206 each include a set of pivot hinges 412, one pivot hinge 412 on each of the top and bottom portions 406,408 of the axle 206. The pivot hinges 412 connect to the carriers 304,326 by means 324 for connecting to a set of pivot hinges, located at the top and bottom of each carrier 304 and preferably within the cylindrical inner portion 310 of the carrier 304. Thus, the ground engaging member 106 and the steerable drive unit 202, including the motor 204, final drive 302 and carrier 304, are configured to pivot about the axle 206 from side to side as one complete unit during steering.

FIG. 6 shows a sectional side view of an axle 206 having two steerable drive units 202 and two ground engaging members 106. FIG. 6 may be described in more detail with additional reference to FIG. 5, which shows a top view of the FIG. 6 configuration.

Specifically, a first ground engaging member 602 includes a first final drive 606 located inside. The first final drive 606 includes a rotating portion 622 fixedly attached to the first ground engaging member 602. The first final drive 606 also includes a non-rotating portion 624. A first carrier 614, also located inside the first ground engaging member 602, is fixedly attached to the non-rotating portion 624. A first motor 610 is located within the first carrier 614 and is drivably engaged with the rotating portion 622 of the first final drive 606.

In like manner, a second ground engaging member 604 includes a second final drive 608 located inside. The second final drive 608 includes a rotating portion 622 fixedly attached to the second ground engaging member 604. The second final drive 608 also includes a non-rotating portion 624. A second carrier 616, also located inside the second ground engaging member 604, is fixedly attached to the non-rotating portion 624. A second motor 612 is located within the second carrier 616 and is drivably engaged with the rotating portion 622 of the second final drive 608.

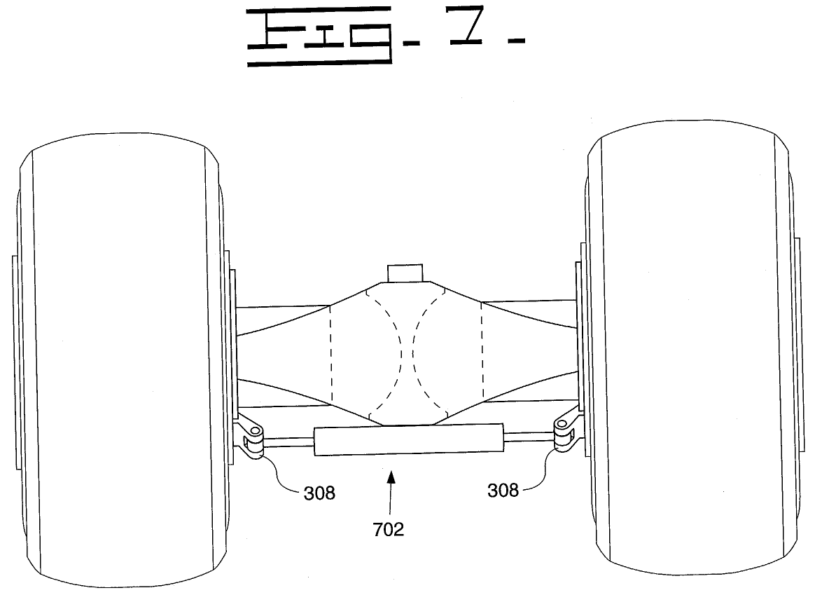

FIG. 7 depicts, for descriptive purposes, a steering linkage assembly 702 connected to the connection brackets 308 located on the carriers 304. The steering linkage assembly 702 is shown in simplified form as a cylinder having rods at both ends, as is commonly used in steering systems. However, it is noted that the steering linkage assembly 702 can be of any type configuration suitable for use on a mobile machine 102 employing the present invention.

Industrial Applicability

As an example of an application of the present invention, many mobile machines are being designed and built which use motors to drivably engage individual ground engaging members. For example, an earthworking machine such as the wheel loader shown in FIG. 1 may have four wheels with tires mounted thereon, and may have four motors to engage the wheels, one motor being dedicated for use with each wheel. As the mobile machines become larger and require more drive torque and more variations in ground speed, the components required to drive the ground engaging members become larger and more complex as well. It then becomes more difficult to position the drive components so that they do not interfere with machine operation. If the ground engaging members must also be allowed to pivot from side to side for steering purposes, the drive components become even more difficult to locate on the machine. The present invention provides a carrier 304 for mounting a motor 204 and a final drive 302 to a ground engaging member 106 on a mobile machine 102. The present invention further provides an axle 206 which allows the motor 204, final drive 302 and carrier 304 to pivot from side to side with the ground engaging member 106 as steering takes place.

Other aspects, objects, and features of the present invention can be obtained from a study of the drawings, the disclosure, and the appended claims.

What is claimed is:

1. An apparatus for providing a steerable drive unit, comprising:
a ground engaging member;
a final drive connected to the ground engaging member;
a motor drivably engaged with the final drive; and
a carrier connected to the motor and the final drive, the carrier including means for connecting to a steering linkage assembly.

2. An apparatus, as set forth in claim 1, wherein the final drive is located within an inner portion of the ground engaging member.

3. An apparatus, as set forth in claim 2, wherein the carrier is located within the inner portion of the ground engaging member.

4. An apparatus, as set forth in claim 3, wherein the carrier includes a cylindrical inner portion for positioning the motor.

5. An apparatus, as set forth in claim 1, wherein the means for connecting to a steering linkage assembly includes a connection bracket.

6. An apparatus, as set forth in claim 1, further including an axle pivotally connected to the carrier.

7. An apparatus, as set forth in claim 6, wherein the axle has a first end pivotally connected to the carrier and a second end pivotally connected to an other carrier.

8. An apparatus, as set forth in claim 7, wherein the axle is essentially tubular.

9. An apparatus, as set forth in claim 8, wherein the first and second ends of the axle each have a top portion and a bottom portion and an open area between the top and bottom portions for providing a space for the motor at the first end and a space for an other motor at the second end.

10. An apparatus, as set forth in claim 9, wherein the axle includes an oscillation pivot located at about a center portion of the axle.

11. An apparatus, as set forth in claim 10, wherein the oscillation pivot includes at least one pin and bushing joint.

12. An apparatus for providing a steerable drive unit, comprising:
a first and a second ground engaging member;
a first final drive connected to the first ground engaging member and a second final drive connected to the second ground engaging member;
a first motor drivably engaged with the first final drive and a second motor drivably engaged with the second final drive; and
a first carrier connected to the first motor and the first final drive and a second carrier connected to the second motor and the second final drive, the first and second carriers including respective first and second connection brackets for connecting to a steering linkage assembly.

13. An apparatus, as set forth in claim 12, further including an axle having a first end pivotally connected to the first carrier and a second end pivotally connected to the second carrier, wherein the first and second ends of the axle each have a top portion and a bottom portion and an open area between the top portion and the bottom portion for providing a space for the first motor at the first end and a space for the second motor at the second end.

14. An apparatus for providing a steerable drive unit, comprising:
a ground engaging member including a wheel and a tire mounted thereon;
a final drive located within an inner portion of the ground engaging member and having a rotating portion fixedly attached to the ground engaging member;
a carrier located within the inner portion of the ground engaging member and attached to a non-rotating portion of the final drive, the carrier being essentially cylindrical with a hollow inner portion; and
a motor positioned within the hollow inner portion of the carrier, attached to the carrier, and drivably engaged with the final drive.

15. An apparatus, as set forth in claim 14, further including an axle having an end pivotally connected to the carrier, the end of the axle further including a top portion and a bottom portion and an open area between the top and bottom portions, wherein the motor is located in the open area.

16. An apparatus, as set forth in claim 15, wherein the carrier includes a connection bracket for connecting to a steering linkage assembly, and wherein the ground engaging member, the final drive, the motor, and the carrier are configured to pivot about the end of the axle in response to control by the steering linkage assembly.

17. An axle for supporting a steerable drive unit, comprising:
an essentially tubular main portion;
a first end having a top portion, a bottom portion, and an open area between the top and bottom portions;
a second end having a top portion, a bottom portion, and an open area between the top and bottom portions;
a pivot hinge located at each of the top and bottom portions of the first and second ends; and
an oscillation pivot located essentially toward the center of the main portion;
wherein each set of pivot hinges at each of the first and second ends are pivotally connected to a steerable drive unit.

18. An axle, as set forth in claim 17, wherein the oscillation pivot includes at least one pin and bushing joint.

19. An axle, as set forth in claim 18, wherein the oscillation pivot is connected to a frame of a mobile machine.

20. An axle, as set forth in claim 17, wherein each open area at the first and second ends provides a space for each steerable drive unit to pivot about each respective set of pivot hinges.

21. A carrier for a steerable drive unit, comprising:
an essentially cylindrical hollow inner portion for locating a motor therein;
a first end fixedly attached to a non-rotating portion of a final drive, the final drive including a rotating portion fixedly attached to a ground engaging member, the motor being drivably engaged with the final drive; and
a second end having means for connecting to a set of pivot hinges located on an axle, the second end further including a connection bracket for connecting to a steering linkage assembly.
